(19) United States
(12) Patent Application Publication
(10) Pub. No.: US 2017/0147043 A1
(43) Pub. Date: May 25, 2017

(54) MOUNTING MEMBER

(71) Applicant: HEWLETT PACKARD ENTERPRISE DEVELOPMENT LP, Houston, TX (US)

(72) Inventor: Earl W MOORE, Cypress, TX (US)

(73) Assignee: HEWLETT PACKARD ENTERPRISE DEVELOPMENT LP, Houston, TX (US)

(21) Appl. No.: 15/323,870

(22) PCT Filed: Jul. 8, 2014
(86) PCT No.: PCT/US14/45786

§ 371 Date: Jan. 4, 2017

(51) Int. Cl. G06F 1/18; A47B 96/07; A47B 96/06; G11B 33/02; G11B 33/12

(52) U.S. Cl. CPC G06F 1/187; G11B 33/022; G11B 33/124; A47B 96/067; A47B 96/07

(57) ABSTRACT

An example mounting assembly is provided herein. The mounting assembly includes a mounting rail member, a support member, and a retention member. The mounting rail member to mount to a rack. The support member extending from the mounting rail member to support a chassis. The retention member extending from the mounting rail member to retain the chassis and a cage rail therein.

### BACKGROUND

Computing systems include hard disk drives. The hard disk drives are typically attached to a hard disk drive carrier then inserted into a computing system. For example, a hard disk drive is attached to a hard disk drive carrier and then inserted into a shelf in a computing system where it is connected to other electronic components.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a mounting assembly according to an example;

FIG. 2 illustrates an isometric view of the assembly of FIG. 1 according to an example;

FIG. 3 illustrates a block diagram of a system according to an example;

FIG. 4 illustrates an isometric view of the system of FIG. 3 according to an example;

FIG. 5 illustrates a cross-sectional view of the system of FIG. 3 according to an example; and

FIG. 6 illustrates a top view of the system of FIG. 3 according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Computing system designs determine requirements for components in the computing system. Space, thermal constraints, cost, and ease of use are some factors that determine the type of mounting assemblies and cages used with electronic components, such as hard disk drives.

In examples, a mounting assembly is provided. The mounting assembly includes a mounting rail member, a support member, and a retention member. The mounting rail member to mount to a rack. The support member extending from the mounting rail member to support a chassis. The retention member extending from the mounting rail member to retain the chassis and a cage rail therein. The mounting assembly transfers a load from a cage to a support structure. The support member provides support to the cage from a bottom end and the retention member provides support from a top end to prevent rotation or twisting when a rail is attached and extended.

The phrase “disk drive” refers to a device to read data from and write data to a disk. For example, a hard disk drive uses a program to read data from and write data to a disk. Examples of a disk drive include a large form factor hard disk drive and a small form factor hard disk drive

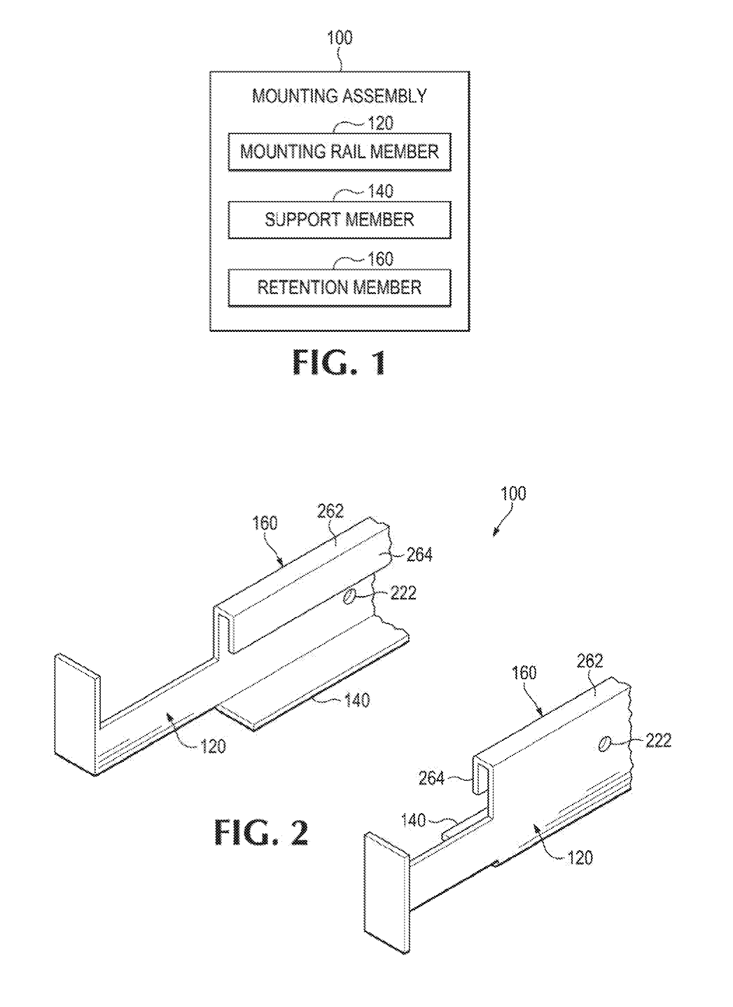

FIG. 1 illustrates a block diagram of a mounting assembly 100 according to an example. The mounting assembly 100 includes a mounting rail member 120, a support member 140, and a retention member 160. The mounting rail member 120 to mount to a support structure. The support member 140 extending from the mounting rail member 120 to support a chassis. The retention member 180 extending from the mounting rail member 120 to retain the chassis and a cage rail member therein.

FIG. 2 illustrates an isometric view of the mounting assembly 100 of FIG. 1 according to an example. The mounting assembly 100 illustrates the mounting rail member 120, the support member 140, and the retention member 160. The mounting rail member 120 is formed of a planar member and may include apertures 222 therein to connect the mounting rail member 120 to a support structure, such as a rack.

The support member 140 extends from the mounting rail member 120. The support member 140 may extend from one end of the mounting rail member 120 in a position approximately perpendicular to the mounting rail member 120. The support member 140 may include for example, a shelf, a ledge, and/or a wall to receive, hold, and/or support a chassis and/or drive cage.

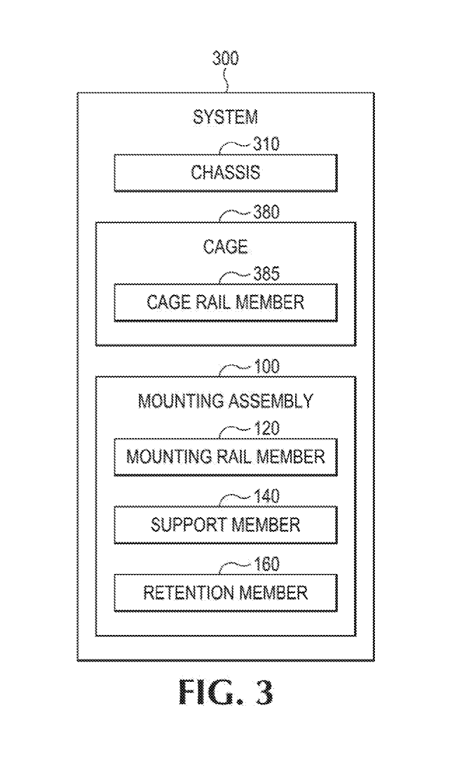

The retention member 160 may include one or more walls extending from the other end of the mounting rail member 120. For example, the retention member 160 may include a first retention member 262 extending approximately perpendicular to the mounting rail member 120 and a second retention member 264 extending from the first member 262 approximately parallel to the mounting rail member 120. The first retention member 262 and/or the second retention member 264 may be formed of a flexible member, such as a cantilever spring, or a rigid member, such as a steel plate. FIGS. 3-6 below illustrate the mounting assembly 100 usable with a chassis and a drive cage.

FIG. 3 illustrates a block diagram of a system 300 according to an example. The system includes a chassis 310, a cage 380, and the mounting assembly 100. The chassis 310 to support an electronic component. The cage 380 connected to the chassis 310 to receive and/or secure the electronic component. The cage 380 includes a cage rail member 385.

The mounting assembly 100 including a mounting rail member 120, a support member 140, and a retention member 160. The mounting rail member 120 to mount to a support structure and receive the cage rail member, The support member 140 extending from the mounting rail member 120 to support a chassis 310. The retention member 160 extending from the mounting rail member 120 to retain the chassis 310 and the cage rail member 385 therein.

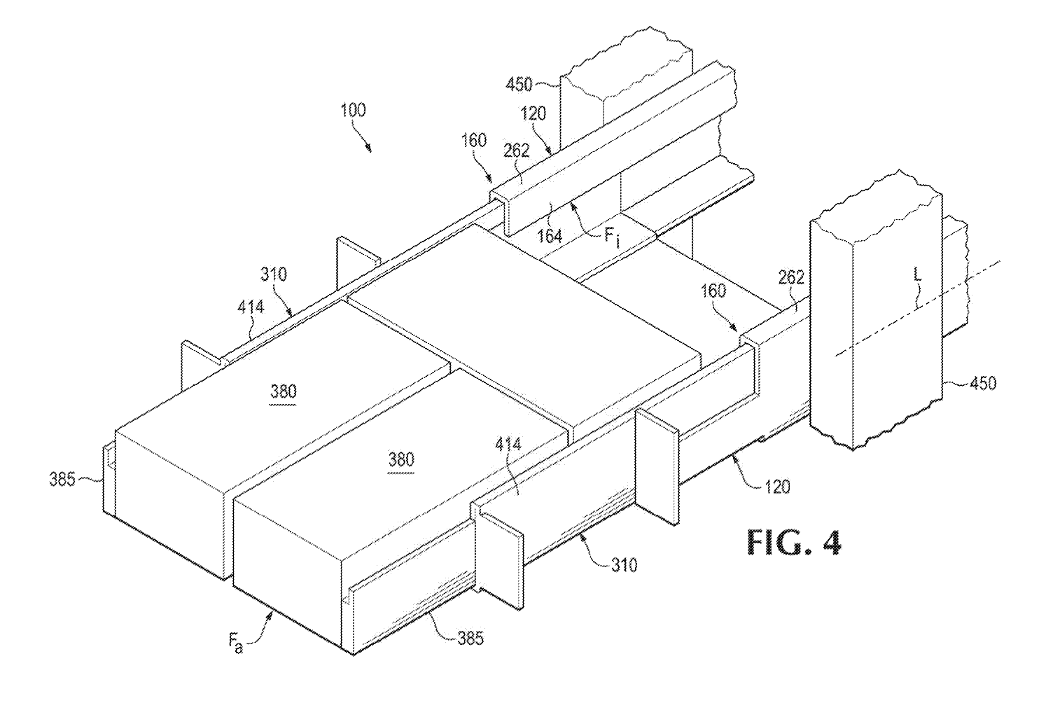

FIG. 4 illustrates an exploded view of the system 300 of FIG. 3 according to an example. The mounting assembly 100 illustrated in FIG. 4, is similar to the mounting assembly 100 illustrated in FIG. 2. The chassis 310 and drive cage 380 connect to the mounting assembly 100 via the cage rail member 385.

The chassis 310 includes a base 412 and a pair of side walls 414. The base 412 to receive and support the cage 380. The pair of side walls 414 extending from opposite sides of the base 412. The pair of side walls 414 to mate with the mounting assembly 100. The mounting assembly 100 and the cage rail member 385 to engage. For example. the retention member 160 applies a first force, Fᵢ, to the cage rail member 385 to maintain a planar or straight path and prevent rotation of the cage rail member 385 as the cage rail member 385 expanded.

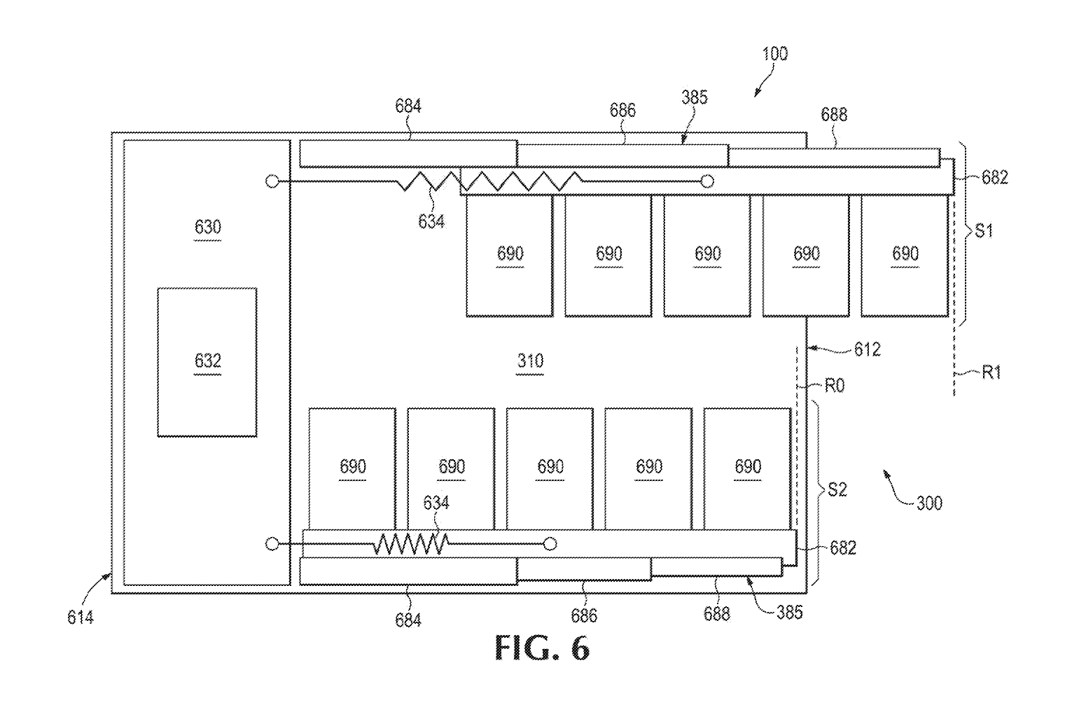

The cage rail member 385 may include, for example, three rails that may extend and retract. The three rails may include a telescoping rail that to extend and retract based on a second force, Fₐ, applied thereto. When the cage rail member 385 is extended the cage rail member 385 engages with the mounting rail member 120 and the second retention member 264, such that, engagement provides support and alignment for the cage rail member 385 and prevents the twisting, turning, or rotation of the cage rail member 385. When the cage rail member 385 is retracted, the three rails may be nested in one another. The three rails are further illustrated in FIG. 6.

The system 300 may further include a support structure 450 to receive the rail assembly 100. For example, the support structure 450 includes a rack. The mounting rail member 120 may connect to the support structure 450. For example, the mounting rail member 120 may include a set of rail members that connect to opposite sides of the support structure 450 or rack along a longitudinal plane, L.

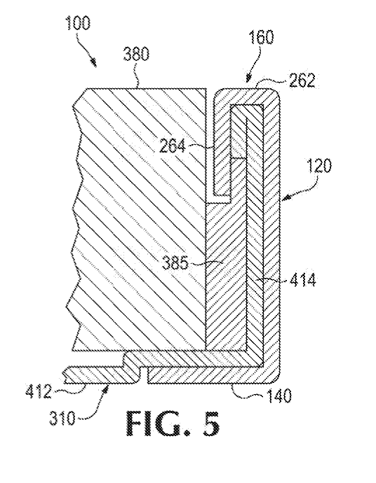

FIG. 5 illustrates a cross-sectional view of the system 300 of FIG. 3 according to an example. Referring to FIG. 5, the system 300 is illustrated in an assembled position with the mounting assembly 100, the chassis 310, and the cage 380 connected.

As illustrated the mounting rail member 120 is formed of a planar member attachable to a support structure, such as a rack. The support member 140 extends from the mounting rail member 120. The support member 140 may extend from one end of the mounting rail member 120 in a position approximately perpendicular to the mounting rail member 120. The support member 140 may include for example, a shelf, a ledge, and/or a wall to receive, hold, and/or support a chassis 310 and/or a cage 380. The support member 140 to transfer the weight or load of the chassis 310 and/or the cage 380 to the support structure 450, such as a rack. The retention member 160 may include one or more walls extending from the other end of the mounting rail member 120. For example, the retention member 160 may include a first retention member 262 extending approximately perpendicular to the mounting rail member 120 and a second retention member 264 extending from the first member 262 approximately parallel to the mounting rail member 120.

The chassis 310 is illustrated as holding a cage 380, such as a drive cage. The cage 380 includes a cage rail member 385 that is connected to the cage 380 and includes a portion thereof extending between the mounting rail member 120 and the retention member 160. Specifically, the cage rail member 385 is positioned between the mounting rail member 120 and the second retention member 264, such that, the mounting rail member 120 engages with the cage rail member 385 when the cage rail member 385 is extended. The engagement provides support and alignment for the cage rail member 385 and prevents the twisting, turning, or rotation of the cage rail member 385.

FIG. 6 illustrates a top view of the system 300 of FIG. 3 according to an example. The system 300 is illustrated to include the chassis 310, the cage 380, and the mounting assembly 100. The chassis 310 includes a plurality of cages 380 connected thereto. The plurality of cages 380 to receive electronic components 690, such as large form factor hard disk drives. The electronic components 690 are illustrated as large form factor hard disk drive cages, each cage 380 may hold, for example two to three hard disk drives. The hard disk drives may be hot pluggable.

The chassis 310 also includes a backplane 682 connectable to the plurality of cages 380 and the electronic components 690 therein. A set of cables 634 may be used to connect the backplane 682 to a back side 630 of the chassis 310. For example, the back side 630 of the chassis 310 may include a power supply 632 and circuit boards 636. The back side 630 may further include fans or other cooling devices.

The mounting assembly 100 illustrated includes a set of mounting rail members 120. The mounting rail members 120 are illustrated as having three rails: a first rail 684, a second rail 686, and a third rail 688. The mounting rail members 120 may include telescoping rails having axial telescoping movement. For example, the set of rail members are illustrated as two mounting rail members 120 connected to each chassis 310. The two mounting rail members 120 are mounted on opposite sides of the support structure 450 or rack. The mounting rail members 120 are designed to operate independent of one another. For example, the electronic components 690 on a first side may be accessed via one of the mounting rail without moving the other mounting rail.

Referring to FIG. 6, a first side S₁ of the chassis 310 includes a first mounting assembly 100A and a second side S₂ of the chassis 310 includes a second mounting assembly 100B. The first side S₁ is illustrated with the cage rail member 385 partially extended R₁. For example, when the first side S₁ is partially extended R₁ the second rail 686 and the third rail 688 are extended from the first rail 684. In the extended position, the cages 380 extend beyond the chassis 510 and are accessible for repair and/or replacement. The second rail 686 and the third rail 688 may further be extended to allow access to each of the cages 380 on the first side S₁. In the extended position R₁, the first cage with large form factor hard disk drive cages 380 is accessible via the front 612 of the chassis 310. The first side S₁ may be pushed back to a retracted position R₀ when access is no longer required or desired.

The second side S₂ is illustrated with the cage rail member 385 in the retracted position R₀. For example, in the retracted position R₀, the second side S₂ is illustrated with the first rail 684, the second rail 686, and the third rail 688 retracted or nested in one another. In the retracted position R₀, the cages on the second side S₂ remain within the chassis 310. The second side S₂ may similarly be extended as illustrated with reference to the first side S₁. As illustrated, the mounting rail member 120 expands and retracts in an axial telescoping movement. Access to the electronic components are provided through the front 612 of the chassis 310, which provides a simple and easy way to access the electronic components without having to access the rear 614 of the chassis 310. Moreover, since the system 300 is compatible with hot pluggable electronic components, the access may be provided without shutting down the whole electronic system.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A mounting assembly comprising:
a mounting rail member to mount to a support member;
the support member extending from the mounting rail member to support a chassis;
a retention member extending from the mounting rail member to retain the chassis and a cage rail member therein.

2. The mounting assembly of claim 1, wherein the mounting member comprises a planar member.

3. The mounting assembly of claim 1, wherein the retention member comprises a first retention member extending approximately perpendicular to the mounting rail member and a second retention member extending from the first retention member approximately parallel to the mounting rail member.

4. The mounting assembly of claim 1, wherein the support member extends approximately perpendicular to the mounting rail member.

5. The mounting assembly of claim 1, wherein the retention member comprises a cantilever spring.

6. A system comprising:
a chassis to support an electronic component;
a cage connected to the chassis to receive the electronic component, the cage including a cage rail member; and
a mounting assembly including:
a mounting rail member to mount to a support member and receive the cage rail member;
a support wall extending from the mounting rail member to support the chassis;
a retention member extending from the mounting rail member to retain the chassis and the cage rail member therein.

7. The system of claim 6, further comprising a support structure to receive the mounting assembly.

8. The system of claim 7, wherein the mounting assembly connects to the support structure along a longitudinal plane.

9. The system of claim herein he support structure comprises a rack.

10. The system of claim 8, wherein the mounting rail member comprises a set of rail members connected to opposing sides of the rack.

11. The system of claim 9, wherein the set of rail members operate independent of one another.

12. The system of claim 6, wherein the mounting rail member and the cage rail member engage.

13. The system of claim 6, wherein the cage rail member comprises a telescoping rail.

14. The system of claim 6, wherein the cage rail member comprises three rails nested in one another.

15. The system of claim 6, wherein the retention member applies a force to the cage rail member to maintain a planar path.
